(19) United States
(12) Patent Application Publication
(10) Pub. No.: US 2011/0011222 A1
(43) Pub. Date: Jan. 20, 2011

(54) Mobile CNC cutting machine

(76) Inventor: Garrie Brian Bales, Mitchell, GA (US)

Correspondence Address: Kenneth Alan Buffington, 4434 Columbia Rd., #100, Martinez, GA, 30907, US

(21) Appl. No.: 12/804,281

(22) Filed: Jul. 19, 2010

Related U.S. Application Data
(60) Provisional application No. 61/271,294, filed on Jul. 20, 2009.

(51) Int. Cl. B26D 5/00; B60R 99/00

(52) U.S. Cl. 83/13; 280/727; 83/72

(57) ABSTRACT

The mobile CNC cutting machine is a mobile automated CNC cutting machine for rapid set-up on a remote job site. The machine is particularly well suited to cut metal materials, and is built on a mobile structure for easy transporting to the job site ready for use.

### CROSS-REFERENCE TO RELATED APPLICATIONS

This application claims the benefit of priority to U.S. Provisional Patent Application No. 61/271,294 filed on Jul. 20, 2009 by the present inventor, the contents of which are incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a CNC cutting machine for cutting a material, and more particularly to a CNC cutting machine which is totally mobile and set-up for cutting metal. The mobile CNC cutting machine can cut the complex plane designs like the large gantry machines permanently installed on the shop floor.

Relevant prior art includes:

U.S. Pat. No. 7,404,754 July 2008 Lin

U.S. Pat. No. 5,871,389 February 1999 Bartlett, et. al.

U.S. Pat. No. 5,383,698 January 1995 Buchholz

U.S. Pat. No. 4,981,318 January 1991 Doane, et. al.

U.S. Pat. No. 4,055,206 October 1977 Griffin

U.S. Pat. No. 7,114,754 October 2006 Morello

A CNC (computer numerical control) cutting machine is a cutting machine tool that uses computer software programs to automatically execute a series of cutting operations. Many types of CNC cutting machines have been provided which include some means for the automated cutting of materials. Although some of the prior art cutting machines have met with some success, the prior art devices possess certain disadvantages. The prior art CNC cutting machines require considerable amount of set-up time which increases the project costs.

Accordingly, a need exists for a CNC cutting machine that does not possess the limitations stated above. In particular, a need exists for a CNC cutting machine that allows minimal set-up time. Additionally, this CNC cutting machine should be mobile in order to quickly reach the job site.

### BRIEF SUMMARY OF THE INVENTION

The present invention is a mobile CNC cutting machine which satisfies all the foregoing needs. A primary object of the present invention is to provide a mobile CNC cutting machine, which is used to cut a material, especially flat metal sheets. The machine typically uses a computer to create the shapes to be cut and control the cutting machine. The resulting shapes are smoother than would be possible with a human hand guided cutting torch, and can include intricate curves, inside cuts, and sharp corners. The machine includes two motorized axes (X and Y) that work together, going forward and backing up in perfect synchronization to produce shapes of virtually any design. The computer also controls the actuation of the torch, turning it on slightly before beginning the cut, to permit it to burn through the material first. To achieve above object, the present invention provides a CNC cutting machine specially designed for mounting on a mobile structure which is towed into the job site ready for use.

### BRIEF DESCRIPTION OF THE DRAWINGS

Referring now to the drawings in which like reference numbers represent corresponding parts throughout:

FIG. 1 is an assembled side view of the mobile CNC cutting machine according to a preferred embodiment of the present invention.

FIG. 2 is another assembled side view of the mobile CNC cutting machine according to a preferred embodiment of the present invention.

FIG. 3 is an end view of the mobile CNC cutting machine according to a preferred embodiment of the present invention.

FIG. 4 is an enlarged cross-sectional end view of the linear guide rail mount assembly of the mobile CNC cutting machine according to a preferred embodiment of the present invention.

FIG. 5 is an enlarged end view of the trolley of the mobile CNC cutting machine according to a preferred embodiment of the present invention.

FIG. 6 is a side view of the main frame of the mobile CNC cutting machine according to a preferred embodiment of the present invention.

### DETAILED DESCRIPTION OF THE INVENTION

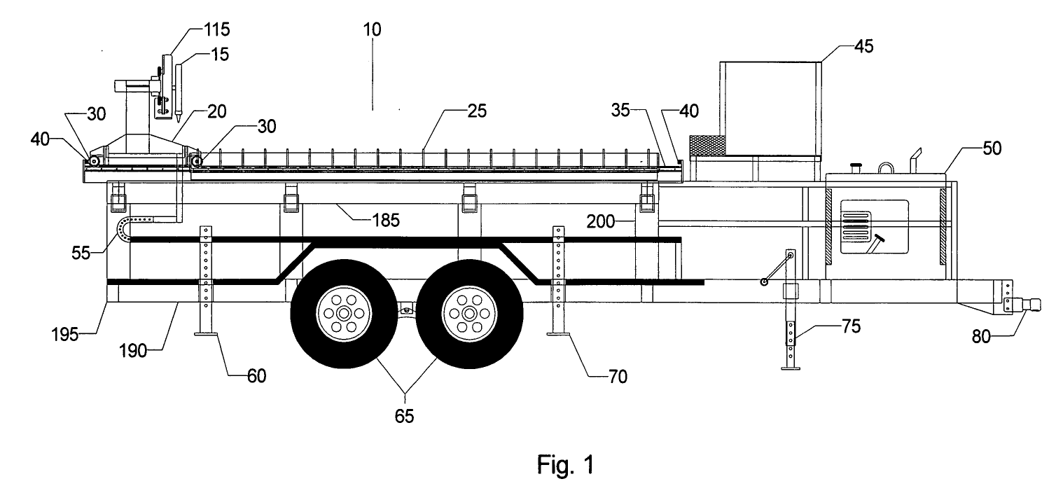

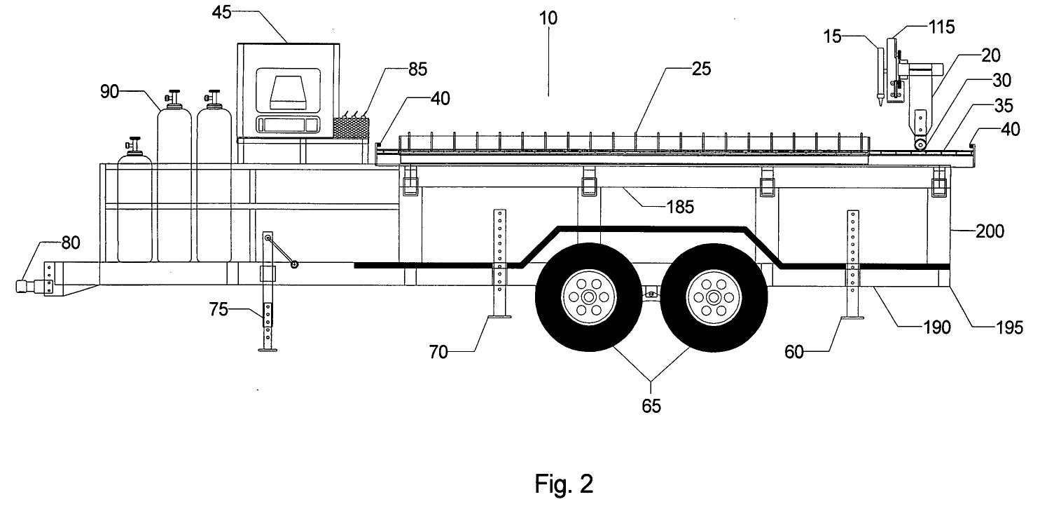

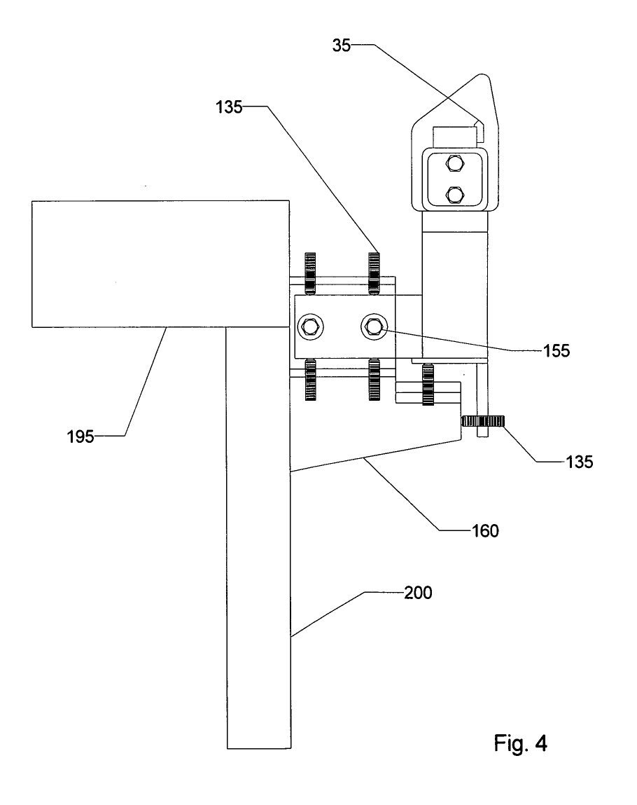

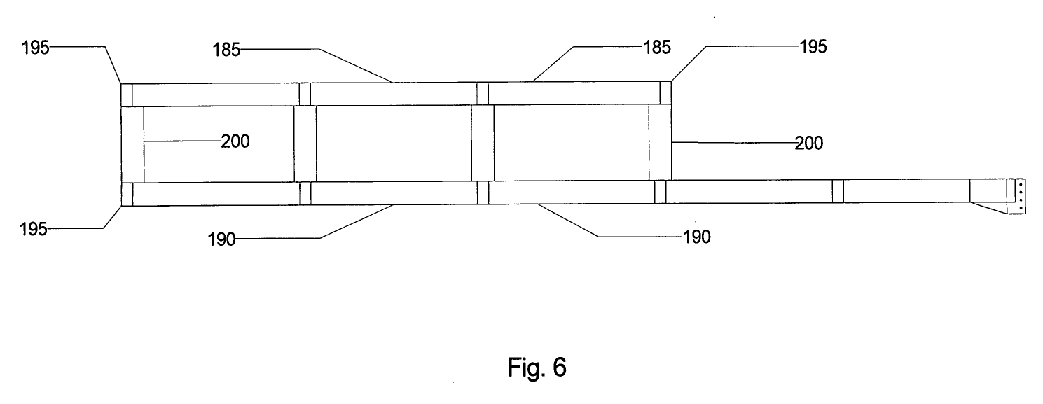

The following description includes the best mode presently contemplated for carrying out the invention. This description is not to be taken in a limiting sense, but is made merely for the purpose of describing the general principles of the invention. The scope of the invention should be determined with reference to the claims. Reference is made to FIGS. 1-6, the mobile CNC cutting machine according to a preferred embodiment of the present invention.

Customarily, the CNC cutting machine is set up on the shop floor inside a building, so the customer must physically go to the shop. The result is that efficiency is less than desirable due to the labor and time spent on set up. The present invention allows the CNC cutting machine to be permanently set up on a transportable, mobile trailer which is easily transportable to the job site. This mobility is a particular advantage to the customer at the jobsite that requires a smaller number of precision parts in a short time during a plant or facility shutdown or outage. This type of trailer has not been used before because of the harsh road environments. The present invention negates the problems previously encountered and makes possible a transportable, mobile CNC cutting machine.

The mobile CNC cutting machine comprises a cutting mechanism 15 mounted on a trolley 115 of a mobile CNC cutting machine 10, wherein the trolley 115 has a motor 108 which is used to position the cutting mechanism 15 along the x-axis of the cutting area 25 and shown in FIGS. 1, 2, and 3. The trolley 115 is mounted on a gantry 20 of a mobile CNC cutting machine 10, wherein the gantry 20 has a motor 133 which is used to position the cutting mechanism 15 along the y-axis of the cutting area 25 and shown in FIGS. 1, 2, and 3.

As shown best in FIGS. 1, 2, and 3, the trolley 115 is mounted on a gantry 20 which has three guide roller bearings 30. The guide roller bearings 30 allow the gantry 20 to roll atop the two linear rails 35 which run the length of the 6′×10′ cutting area 25. Rubber stops 40 are attached to the ends of the linear rails to prevent the gantry 20 from derailing. A cable and hose carrier 55 is provided to festoon the cable and hose connections from the computer console 45, power supply 50, oxygen and acetylene tanks 90, and gas control valves 85 to the gantry 20. The control console 45 is used to display and set operational parameters for operating the cutting mechanism 15. The control console 45 is any type of industrial computer with a processor and hard drive to include a programmable logic controller (PLC) or personal computer. The control console 45 processes the software that controls the cutting process which is typically CAD/CAM (Computer Aided Design/Computer Aided Manufacturing) type software. The control console 45 interfaces to a typical laptop or other portable computer to receive programming instructions. The laptop or other portable computer includes a wireless card to receive programming software via a wireless network.

As shown best in FIGS. 1, 2, 3, and 6, the structure of a mobile CNC cutting machine 10 includes an upper frame 185 and a lower frame 190 which are connected together with horizontal braces 195 and vertical braces 200. A typical structure is fabricated from 3″×6″×¼″ steel tubing. The steel tubing for the lower frame 190 is typically 20′ in length. The vertical braces 200 and horizontal braces 195 are typically joined at the same point to provide a rigid frame design which is built to withstand all traveling conditions including a harsh road environment. Adjusting rear retractable stabilizers 60, front retractable stabilizers 70, 12, 500 lb. rated hitch 80, and lift jack 75 are attached to the mobile CNC cutting machine 10 structure. The entire mobile CNC cutting machine 10 structures rests upon 5,200 lb. rated tandem axles 65.

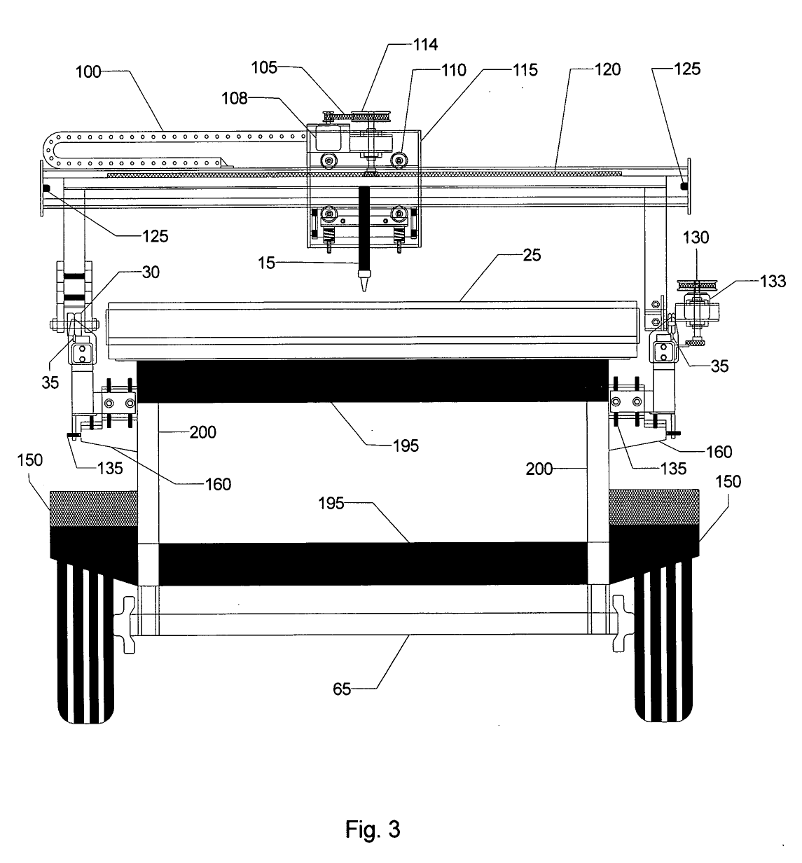

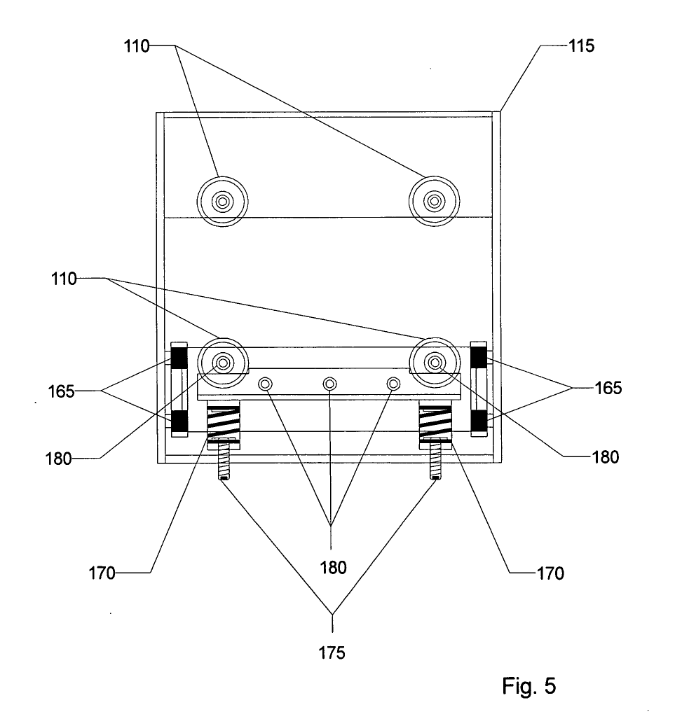

As shown best in FIGS. 3 and 5, the end view of a mobile CNC cutting machine 10 shows in greater detail the trolley 115 mounted on the gantry 20. The trolley 115 is mounted to the gantry 20 with four guide roller bearings 110. The trolley motor 108 is connected to a trolley speed reducer 114 by a belt drive speed reducer belt 105. The trolley speed reducer 114 is attached to a geared shaft which is propelled along the gear rack 120. The cutting mechanism 15 is attached to the trolley 115 and is positioned downwards towards the 6′×10′ cutting area 25. The trolley 115 runs approximately the entire width of the 6′×10′ cutting area 25. A trolley cable and hose carrier 100 festoons the cables and hoses to the trolley motor 108 and cutting mechanism 15. Each end of the gantry 20 is provided with rubber stops 125 to cushion the trolley 115.

As shown on FIGS. 3, 4, and 6, the linear guide rail mount 160 is attached to a vertical brace 200 towards the end. Set screws 135 and hexagonal cap screws 155 are provided to adjust the linear guide rail 35. The mounting is designed to adjust inwards and outwards, up and down, and tilt from side to side. The design allows the user to easily adjust the linear guide rail to maintain proper alignment.

The x-axis trolley is designed to handle harsh road environments. The lower guide rail assembly is spring loaded into the lower guide rail. The assembly is held in place by vertical mounted cam followers in such a way that maintains proper rail alignment. FIG. 5 shows a more detailed view of the trolley 115 which is provided with four guide roller bearings 110 that attach the trolley 115 to the gantry 20. The guide roller bearings 110 are adjusted by set screws 175, socket head cap screws, and coil spring 170. Also, cam follower bearings 165 help hold the lower guide roller bearing assembly, which is spring loading the trolley 115 to the gantry 20 from the side.

Referring still to FIGS. 1-6, in the preferred embodiment of the present invention, all elements as described above are used to commonly construct the whole cutting machine 10. The operator typically tows the cutting machine to the jobsite with a standard vehicle that has a trailer hitch. The operator secures the cutting machine 10 in a level and stationary position by adjusting rear retractable stabilizers 60, front retractable stabilizers 70, and lift jack 75. The operator secures the material to be cut; typically flat metal sheets, in the 6x10 cutting area 25. The operator at the control console 45 sets operation parameters by interfacing the control console 45 with a laptop, so as to carry out a completely automatic cutting operation without manually processing, and providing precise and speedy cutting of the material. The laptop uploads the appropriate CAD/CAM software for the particular job. The operator also checks for any last minute cutting parameter changes in the job over the wireless network. The control console 45 via the CAD/CAM software controls the positioning of the gantry 20 and trolley 115. The gantry 20 positions the cutting mechanism 15 along the y-axis of the material to be cut in the 6×10 cutting area 25. The trolley 115 positions the cutting mechanism 15 along the x-axis of the material to be cut in the 6×10 cutting area 25. The x-axis and y-axis motion of the cutting mechanism 15 allows precise cuts of any shape or design as set in the control console 45.

Compared with the conventional CNC cutting machines, the mobile CNC cutting machine according to the preferred embodiment of the present invention provides functions and advantages. The mobile CNC cutting machine carries out the completely automatic cutting operation without manually processing. A significant feature of the Mobile CNC Cutting Machine is that its mobility saves manpower and set-up time. While a CNC machine is in set-up, it cannot be producing any work pieces. This non-productive time can never be recovered. The reduction in set-up time reduces the manufacturing costs. The Mobile CNC Cutting Machine can be towed in and typically set-up in 15 minutes.

Many variations of the invention will occur to those skilled in the art. Some variations include the CNC cutting machine dimensions; and the type of cutting mechanism. All such variations are intended to be within the scope and spirit of the invention. Although some embodiments are shown to include certain features, the applicant specifically contemplates that any feature disclosed herein may be used together or in combination with any other feature on any embodiment of the invention. It is also contemplated that any feature may be specifically excluded from any embodiment of an invention.

What is claimed is:

1. A mobile apparatus which may be moved from a first location to a second location, said apparatus comprising:
a frame onto which an automated cutting machine is mounted for cutting flat metal sheets; said frame having at least one axle and said frame having a means of attachment to a tow vehicle.

2. Apparatus of claim 1 wherein the said automated cutting machine is controlled by a control console.

3. Apparatus of claim 1 wherein the said automated cutting machine is controlled by computer numerical control (CNC) algorithms.

4. Apparatus of claim 2 wherein the said control console comprises a wireless card to interface with a wireless network.

5. Apparatus of claim 2 wherein the said control console further comprises a hard drive and processor.

6. Apparatus of claim 5 wherein the said hard drive and processor interface to a laptop or other portable computer.

7. Apparatus of claim 5 wherein the said hard drive and processor process computer aided design (CAD) and computer aided manufacturing (CAM) software.

8. A mobile apparatus of claim 1 wherein the said automated cutting machine is controlled by computer numerical control (CNC) algorithms.

9. Apparatus of claim 1 wherein the said automated cutting machine includes an X-axis trolley and Y-axis gantry.

10. Apparatus of claim 9 wherein the said X-axis trolley includes a cutting torch.

11. Apparatus of claim 1 wherein the said machine is permanently mounted to said frame.

12. Apparatus of claim 1 wherein the said axle further includes at least one tire mounted on opposite ends.

13. Apparatus of claim 9 wherein the said X-axis trolley includes vertical cam followers thereby maintaining proper rail alignment.

14. Apparatus of claim 1 wherein the said means of attachment to a tow vehicle includes a trailer hitch.

15. A method of cutting flat metal sheets at the jobsite comprising: towing a trailer with a permanently mounted automated cutting machine apparatus to a location where said cutting is in demand; securing the said sheets in the cutting area on said machine; and setting the cutting parameters on the control console.

16. A mobile metal cutting apparatus comprising:
a) a trailer with at least one axle and two wheels on opposite ends of said axle whereby said apparatus is permanently mounted on said trailer;
b) a control console for controlling the cutting process;
c) a trolley for X-axis motion whereby said trolley includes a cutting torch; and
d) a gantry for Y-axis motion;
whereby said machine is towed from a first location to a second location.

17. Apparatus of claim 16 wherein the said automated cutting machine is controlled by computer numerical control (CNC) algorithms.

18. Apparatus of claim 16 wherein the said control console further comprises a hard drive and processor, and wireless card.

19. Apparatus of claim 18 wherein the said hard drive and processor interface to a laptop or other portable computer.

20. Apparatus of claim 18 wherein the said hard drive and processor process computer aided design (CAD) and computer aided manufacturing (CAM) software.
